(19) United States
(12) Patent Application Publication
(10) Pub. No.: US 2012/0260219 A1
(43) Pub. Date: Oct. 11, 2012

(54) METHOD OF CURSOR CONTROL

(76) Inventor: Jose P. Piccolotto, Cordoba (AR)

(21) Appl. No.: 13/083,197

(22) Filed: Apr. 8, 2011

(51) Int. Cl. G06F 3/048; G09G 5/08

(52) U.S. Cl. 715/856; 345/157

(57) ABSTRACT

A processing system includes a touch screen display, and another input device such as a track pad and/or mouse. The processing system includes a graphical user interface (GUI) having a cursor control component to hide the cursor on the touch screen display when an input signal is sensed from the touch screen display, and to show the cursor on the touch screen display when the input signal is sensed from the other input device.

### FIELD

The present disclosure generally relates to the field of graphical user interfaces (GUIs) in processing systems. More particularly, an embodiment of the invention relates to controlling a cursor in a GUI of a processing system.

### BACKGROUND

When using a track pad, mouse or other pointing input device, a cursor is typically shown on a display to indicate the current location of the pointing device. Some processing systems have a track pad, mouse, or other pointing input device as well as a touch screen display. In such a processing system, having dual navigational usage models (e.g., touch screen and track pad, mouse or other pointing device) may result in poor user experiences due to inadequate handling of the cursor.

### BRIEF DESCRIPTION OF THE DRAWINGS

The detailed description is provided with reference to the accompanying figures. The use of the same reference numbers in different figures indicates similar or identical items.

FIG. 1 is a diagram of a processing system according to an embodiment of the present invention.

FIG. 2 is a flow diagram of controlling a cursor according to an embodiment of the present invention.

FIGS. 3 and 4 illustrate block diagrams of embodiments of processing systems, which may be utilized to implement some embodiments discussed herein.

### DETAILED DESCRIPTION

Embodiments of the present invention overcome deficiencies in existing processing systems having a dual navigation mode. When a processing system has a track pad, mouse, or other pointing input device, and a touch screen, embodiments of the present invention show a cursor on the display when the track pad, mouse, or other pointing input device is being used, and hide the cursor from the display when the touch screen is being used.

In the following description, numerous specific details are set forth in order to provide a thorough understanding of various embodiments. However, various embodiments of the invention may be practiced without the specific details. In other instances, well-known methods, procedures, components, and circuits have not been described in detail so as not to obscure the particular embodiments of the invention. Further, various aspects of embodiments of the invention may be performed using various means, such as integrated semiconductor circuits (“hardware”), computer-readable instructions organized into one or more programs stored on a computer readable storage medium (“software”), or some combination of hardware and software. For the purposes of this disclosure reference to “logic” shall mean either hardware, software (including for example micro-code that controls the operations of a processor), firmware, or some combination thereof.

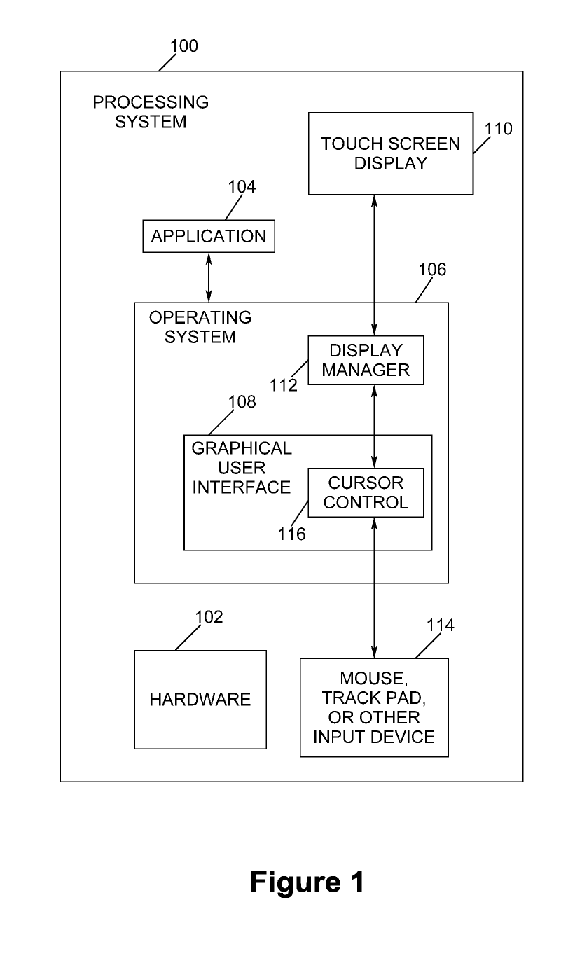

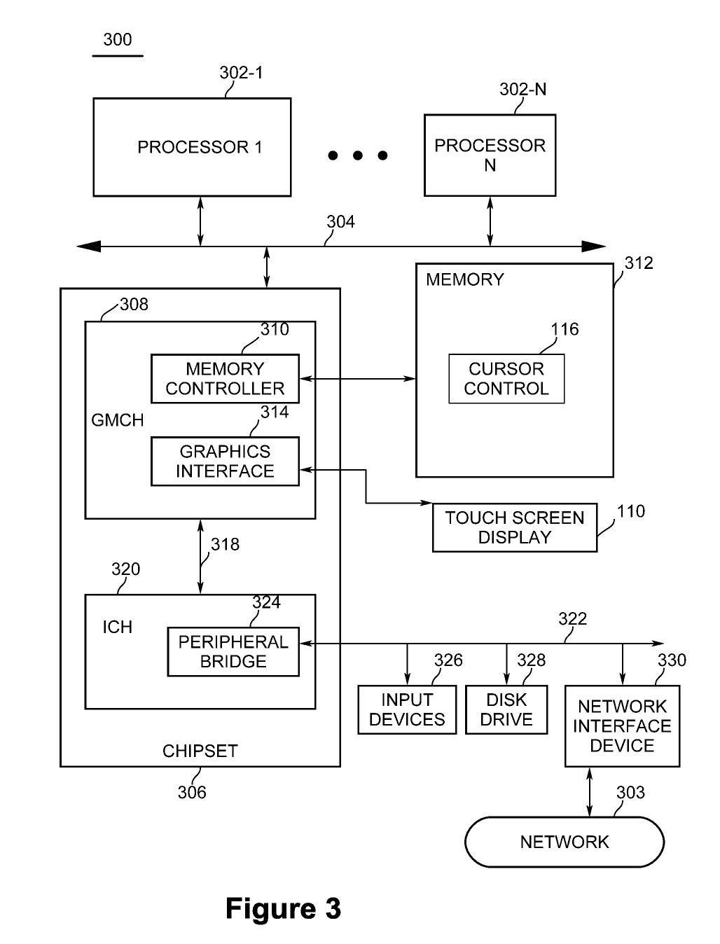

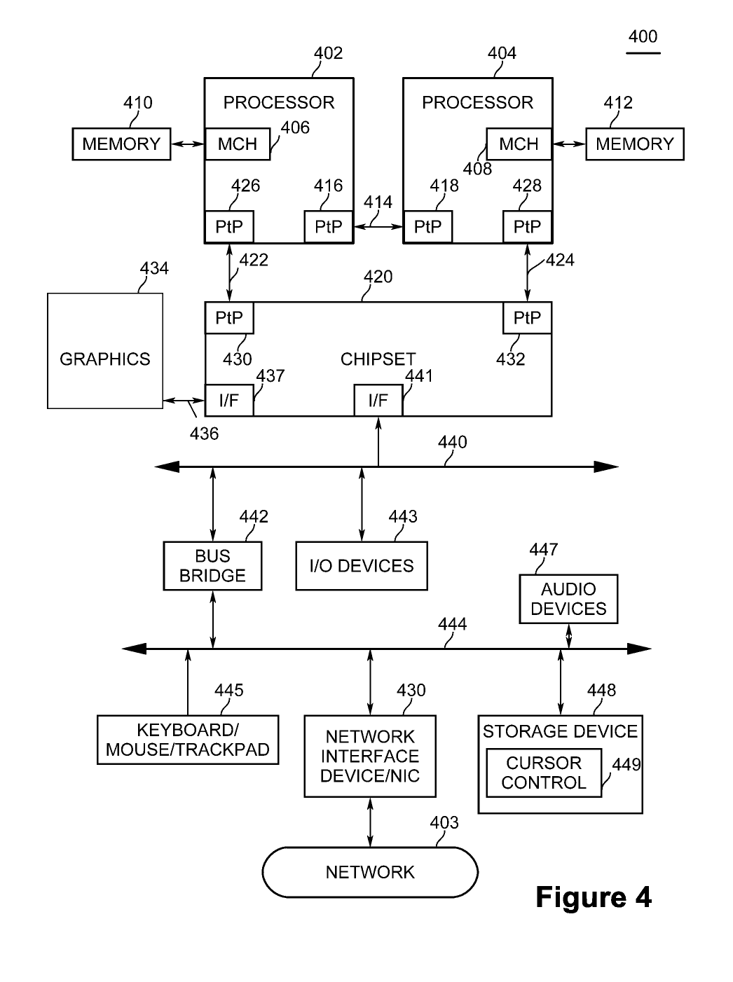

FIG. 1 is a diagram of a processing system according to an embodiment of the present invention. In various embodiments, processing system 100 may be a personal computer (PC), a laptop computer, a netbook, a tablet computer, a handheld computer, a smart phone, a mobile Internet device (MID), or any other stationary or mobile processing device. As shown in the simplified diagram of FIG. 1, processing system 100 comprises hardware 102 (which will be further discussed with reference to FIGS. 3 and 4). Application 104 may be an application program to be executed on the processing system. In various embodiments, the application program may be a standalone program, or a part of another program (such as a plug-in, for example), for a web browser, image processing application, game, or multimedia application, for example. Operating system (OS) 106 interacts with application 104 and hardware 102 to control the operation of the processing system as is well known. OS 106 comprises a graphical user interface (GUI) 108 to manage the interaction between the user and various input and output devices. Processing system 100 comprises multiple input and output devices. Touch screen display 110 may be included in the system to display output data to the user as well as accept input signals from the user via the touch screen. In an embodiment, the OS may include a display manager component 112 to manage the input data from and the output data to touch screen display 110. Mouse, track pad, or other pointing input device 114 accepts user input selections based at least in part on the display of a cursor on a display (such as touch screen display 110 in one embodiment) as is well known. In various embodiments, other pointing input devices may comprise a trackball, a pointing stick, a graphics table (e.g., a digitizing tablet), or other similar devices used for pointing or indicating a location on a display.

In an embodiment, GUI 108 comprises cursor control component 116 to manage the display of the cursor on the touch screen display. Cursor control component 116 may receive input signals, either directly or indirectly, from a mouse, track pad, or other pointing input device, or from touch screen display 110 via display manager 112. In an embodiment, cursor control component 116 determines whether to cause the display of the cursor on the touch screen display or not depending on how the user is using the processing system.

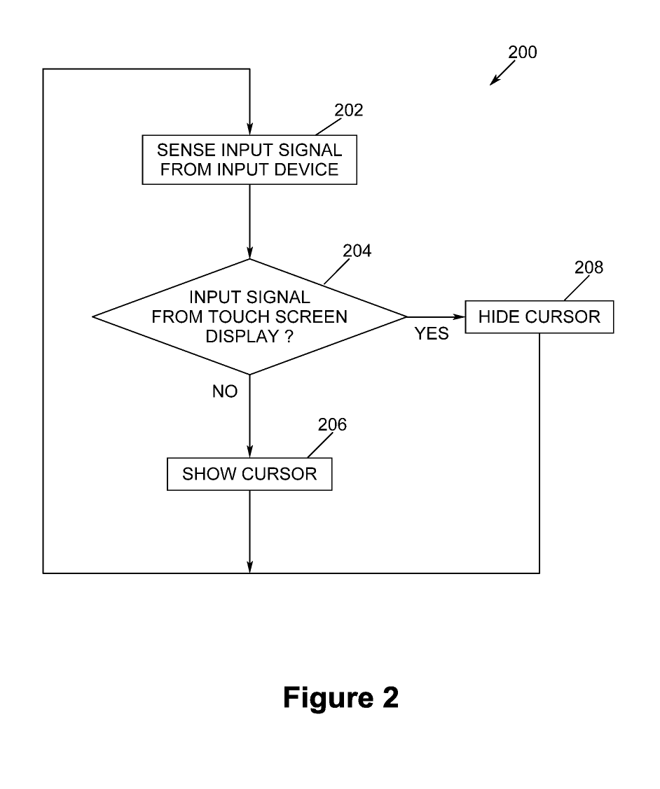

FIG. 2 is a flow diagram 200 of controlling a cursor according to an embodiment of the present invention. In an embodiment, at least one of the processing steps of FIG. 2 may be implemented by cursor control component 116 of the GUI 108. At block 202, an input signal may be sensed from an input device of the processing system and the source of the input signal may be determined. In an embodiment, sensing of the input signal and handling of this event may be processed by an interrupt mechanism as is well known. In an embodiment, an input signal may be sensed because the input device has been connected to the processing system or because of some user movement has been detected by the input device. At block 204, if the input signal is from the touch screen display, cursor control component 116 indicates to GUI 108 and/or display manager 112 to hide the cursor. That is, the touch screen display does not display the cursor when the user is operating the processing system by causing input signals to the touch screen display. If the input signal is not from the touch screen display, it may be assumed that the input signal is from a track pad, a mouse, or another pointing input device. In this case, the cursor control component indicates at block 206 to the GUI and/or the display manager to show the cursor on the touch screen display. In either case, processing continues with the next sensed input signal at block 202.

Thus, this cursor control mechanism provides a better user experience because the user sees the cursor on the display when the user operates the track pad, mouse, or other pointing input device, and does not see the cursor on the display when the user operates the touch screen display.

FIG. 3 illustrates a block diagram of an embodiment of a processing system 300. In various embodiments, one or more of the components of the system 300 may be provided in various electronic devices capable of performing one or more of the operations discussed herein with reference to some embodiments of the invention. For example, one or more of the components of the system 300 may be used to perform the operations discussed with reference to FIGS. 1-2, e.g., by processing instructions, executing subroutines, etc. in accordance with the operations discussed herein. Also, various storage devices discussed herein (e.g., with reference to FIG. 3 and/or FIG. 4) may be used to store data, operation results, etc. In one embodiment, data may be received over the network 303 (e.g., via network interface devices 330 and/or 430) may be stored in caches (e.g., L1 caches in an embodiment) present in processors 302 (and/or 402 of FIG. 4). These processors may then apply the operations discussed herein in accordance with various embodiments of the invention.

More particularly, the processing system 300 may include one or more central processing unit(s) 302 or processors that communicate via an interconnection network (or bus) 304. Hence, various operations discussed herein may be performed by a processor in some embodiments. Moreover, the processors 302 may include a general purpose processor, a network processor (that processes data communicated over a computer network 303, or other types of a processor (including a reduced instruction set computer (RISC) processor or a complex instruction set computer (CISC)). Moreover, the processors 302 may have a single or multiple core design. The processors 302 with a multiple core design may integrate different types of processor cores on the same integrated circuit (IC) die. Also, the processors 302 with a multiple core design may be implemented as symmetrical or asymmetrical multiprocessors. Moreover, the operations discussed with reference to FIGS. 1-2 may be performed by one or more components of the system 300. In an embodiment, a processor (such as processor 1 302-1) may comprise cursor control 116, GUI 108, and OS 106 as hardwired logic (e.g., circuitry) or microcode.

A chipset 306 may also communicate with the interconnection network 304. The chipset 306 may include a graphics and memory control hub (GMCH) 308. The GMCH 308 may include a memory controller 310 that communicates with a memory 312. The memory 312 may store data and/or instructions. The data may include sequences of instructions that are executed by the processor 302 or any other device included in the processing system 300. Furthermore, memory 712 may store one or more of the programs or algorithms discussed herein such as cursor control 116, GUI 108, and OS 106, instructions corresponding to executables, mappings, etc. The same or at least a portion of this data (including instructions, and temporary storage arrays) may be stored in disk drive 328 and/or one or more caches within processors 302. In one embodiment of the invention, the memory 312 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk. Additional devices may communicate via the interconnection network 304, such as multiple processors and/or multiple system memories.

The GMCH 308 may also include a graphics interface 314 that communicates with touch screen display 110. In one embodiment of the invention, the graphics interface 314 may communicate with the touch screen display 110 via an accelerated graphics port (AGP). In an embodiment of the invention, the display 110 may be a flat panel display that communicates with the graphics interface 314 through, for example, a signal converter that translates a digital representation of an image stored in a storage device such as video memory or system memory into display signals that are interpreted and displayed by the display 110. The display signals produced by the interface 314 may pass through various control devices before being interpreted by and subsequently displayed on the display 110. In an embodiment, cursor control 116 may be implemented as circuitry within graphics interface 314 or elsewhere within the chipset.

A hub interface 318 may allow the GMCH 308 and an input/output (I/O) control hub (ICH) 320 to communicate. The ICH 320 may provide an interface to I/O devices that communicate with the processing system 300. The ICH 320 may communicate with a bus 322 through a peripheral bridge (or controller) 324, such as a peripheral component interconnect (PCI) bridge, a universal serial bus (USB) controller, or other types of peripheral bridges or controllers. The bridge 324 may provide a data path between the processor 302 and peripheral devices. Other types of topologies may be utilized. Also, multiple buses may communicate with the ICH 320, e.g., through multiple bridges or controllers. Moreover, other peripherals in communication with the ICH 320 may include, in various embodiments of the invention, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 322 may communicate with input devices 326 (such as a track pad, mouse, our other pointing input device), one or more disk drive(s) 328, and a network interface device 330, which may be in communication with the computer network 303 (such as the Internet, for example). In an embodiment, the device 330 may be a network interface controller (NIC) capable of wired or wireless communication. Other devices may communicate via the bus 322. Also, various components (such as the network interface device 330) may communicate with the GMCH 308 in some embodiments of the invention. In addition, the processor 302, the GMCH 308, and/or the graphics interface 314 may be combined to form a single chip.

Furthermore, the processing system 300 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 328), a floppy disk, a compact disk ROM (CD-ROM), a digital versatile disk (DVD), flash memory, a magneto-optical disk, or other types of nonvolatile machine-readable media that are capable of storing electronic data (e.g., including instructions).

In an embodiment, components of the system 300 may be arranged in a point-to-point (PtP) configuration such as discussed with reference to FIG. 4. For example, processors, memory, and/or input/output devices may be interconnected by a number of point-to-point interfaces.

More specifically, FIG. 4 illustrates a processing system 400 that is arranged in a point-to-point (PtP) configuration, according to an embodiment of the invention. In particular, FIG. 4 shows a system where processors, memory, and input/output devices are interconnected by a number of point-to-point interfaces. The operations discussed with reference to FIGS. 1-2 may be performed by one or more components of the system 400.

As illustrated in FIG. 4, the system 400 may include multiple processors, of which only two, processors 402 and 404 are shown for clarity. The processors 402 and 404 may each include a local memory controller hub (MCH) 406 and 408 (which may be the same or similar to the GMCH 308 of FIG. 3 in some embodiments) to couple with memories 410 and 412. The memories 410 and/or 412 may store various data such as those discussed with reference to the memory 312 of FIG. 3.

The processors 402 and 404 may be any suitable processor such as those discussed with reference to processors 302 of FIG. 3. The processors 402 and 404 may exchange data via a point-to-point (PtP) interface 414 using PtP interface circuits 416 and 418, respectively. The processors 402 and 404 may each exchange data with a chipset 420 via individual PtP interfaces 422 and 424 using point to point interface circuits 426, 428, 430, and 432. The chipset 420 may also exchange data with a high-performance graphics circuit 434 via a high-performance graphics interface 436, using a PtP interface circuit 437. Graphics 424 may be coupled with a touch screen display 110 (not shown in FIG. 4).

At least one embodiment of the invention may be provided by utilizing the processors 402 and 404. For example, the processors 402 and/or 404 may perform one or more of the operations of FIGS. 1-2. Other embodiments of the invention, however, may exist in other circuits, logic units, or devices within the system 400 of FIG. 4. Furthermore, other embodiments of the invention may be distributed throughout several circuits, logic units, or devices illustrated in FIG. 4.

The chipset 420 may be coupled to a bus 440 using a PtP interface circuit 441. The bus 440 may have one or more devices coupled to it, such as a bus bridge 442 and I/O devices 443. Via a bus 444, the bus bridge 443 may be coupled to other devices such as a keyboard/mouse/track pad 445, the network interface device 430 discussed with reference to FIG. 3 (such as modems, network interface cards (NICs), or the like that may be coupled to the computer network 303), audio I/O device 447, and/or a data storage device 448. The data storage device 448 may store, in an embodiment, cursor control instructions 449 that may be executed by the processors 402 and/or 404.

In various embodiments of the invention, the operations discussed herein, e.g., with reference to FIGS. 1-4, may be implemented as hardware (e.g., logic circuitry), software (including, for example, micro-code that controls the operations of a processor such as the processors discussed with reference to FIGS. 3 and 4), firmware, or combinations thereof, which may be provided as a computer program product, e.g., including a tangible machine-readable or computer-readable medium having stored thereon instructions (or software procedures) used to program a computer (e.g., a processor or other logic of a computing device) to perform an operation discussed herein. The machine-readable medium may include a storage device such as those discussed herein.

Reference in the specification to “one embodiment” or “an embodiment” means that a particular feature, structure, or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments of the invention, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Additionally, such computer-readable media may be downloaded as a computer program product, wherein the program may be transferred from a remote computer (e.g., a server) to a requesting computer (e.g., a client) by way of data signals, via a communication link (e.g., a bus, a modem, or a network connection).

Thus, although embodiments of the invention have been described in language specific to structural features and/or methodological acts, it is to be understood that claimed subject matter may not be limited to the specific features or acts described. Rather, the specific features and acts are disclosed as sample forms of implementing the claimed subject matter.

1. In a processing system having a touch screen display and a second input device, a method of controlling a cursor comprising:
sensing an input signal from one of the touch screen display and the second input device;
hiding the cursor on the touch screen display when the input signal is from the touch screen display; and
showing the cursor on the touch screen display when the input signal is from the second input device.

2. The method of claim 1, wherein the second input device comprises a mouse.

3. The method of claim 1, wherein the second input device comprises a track pad.

4. A machine-readable medium comprising one or more instructions that when executed on a processor of a processing system, the processing system including a touch screen display and a second input device, to perform one or more operations to control a cursor on the touch screen display by sensing an input signal from one of the touch screen display and the second input device; hiding the cursor on the touch screen display when the input signal is from the touch screen display; and showing the cursor on the touch screen display when the input signal is from the second input device.

5. The machine-readable medium of claim 4, wherein the second input device comprises a mouse.

6. The machine-readable medium of claim 4, wherein the second input device comprises a track pad.

7. A processing system comprising:
a touch screen display;
a second input device; and
a graphical user interface (GUI) coupled to the touch screen display and the second input device, the GUI comprising a cursor control component to hide the cursor on the touch screen display when an input signal is sensed from the touch screen display, and to show the cursor on the touch screen display when the input signal is sensed from the second input device.

8. The processing system of claim 7, wherein the second input device comprises a mouse.

9. The processing system of claim 7, wherein the second input device comprises a track pad.
